(19) United States
(12) Patent Application Publication
(10) Pub. No.: US 2012/0140888 A1
(43) Pub. Date: Jun. 7, 2012

(54) X-RAY DIFFRACTION INSTRUMENT

(75) Inventor: Yun WANG, Hitachi (JP)

(73) Assignee: Hitachi-GE Nuclear Energy, Ltd.

(21) Appl. No.: 13/308,602

(22) Filed: Dec. 1, 2011

(30) Foreign Application Priority Data
Dec. 6, 2010 (JP) 2010-271107

(51) Int. Cl. G01N 23/207

(52) U.S. Cl. 378/71

(57) ABSTRACT

It is an objective of the present invention to provide an X-ray diffraction instrument which does not require any actuator for adjusting a position and/or an orientation of a measurement object and/or an X-ray emitter used in the instrument and that has no particular limitation on a size and a shape of the measurement object. There is provided an X-ray diffraction instrument including: a two-dimensional plate-like X-ray detector; an X-ray emitter integrated with the X-ray detector in such a manner that the X-ray emitter penetrates the plate of the X-ray detector; and a cylinder-like shield for defining an orientation of the X-ray emitter and preventing X-ray leakage, the X-ray detector being attached to an end of the cylinder-like shield in such a manner that a perimeter of the end of the shield abuts a perimeter of the plate of the X-ray detector.

### CLAIM OF PRIORITY

The present application claims priority from Japanese patent application serial no. 2010-271107 filed on Dec. 6, 2010, the content of which is hereby incorporated by reference into this application.

### BACKGROUND OF THE INVENTION

1. Field of the Invention

The present invention relates to X-ray diffraction instruments, and particularly to X-ray diffraction instruments including a two-dimensional X-ray detector.

2. Description of Related Art

X-ray diffraction instruments are used as a non-destructive inspection tool for measuring various material properties (such as crystallographic structure, composition and residual stress). Goniometers, zero-dimensional scintillation counters (SC), one-dimensional position sensitive detectors (PSD), etc. are commonly and widely used to obtain X-ray diffraction data (such as intensity and angle of diffraction). However, these instruments offer only zero-/one-dimensional diffraction data by a single measurement. Thus, a complicated actuator and a long total measurement time are needed to obtain sufficient diffraction data required for a thoroughly satisfactory material analysis.

To overcome this disadvantage, X-ray diffraction instruments including a two-dimensional X-ray detector which provide a larger amount of diffraction information in a shorter period of measurement time are used. Examples of two-dimensional X-ray detectors include two-dimensional position sensitive proportional counters (PSPC) and imaging plates (IP). Imaging plates are a type of ionizing radiation image detector in which a photostimulable phosphor such as BaFX:Eu²⁺ (X=Br, I) is applied on a support plate made of a plastic or the like.

JP-A 2000-146871 discloses a micro X-ray diffraction instrument and a method of measurement, in which a micro area of a specimen is irradiated with an X-ray beam and the X-ray beams diffracted by the specimen are detected by a two-dimensional X-ray detector. The two-dimensional X-ray detector used in this micro X-ray diffraction instrument is a cylinder made of a photostimulable phosphor, and is placed in such a manner as to surround the specimen. The specimen is tilted (e.g., by 45°) so that both the X-ray beams diffracted in directions tangential to the specimen surface and the X-ray beams diffracted in directions normal to the specimen surface can be detected by the photostimulable phosphor X-ray detector. By using the JP-A 2000-146871 X-ray diffraction instrument, sufficient X-ray diffraction data can be captured by the photostimulable phosphor detector by rotating the specimen around only one axis (normal to the specimen surface), which is advantageous over most conventional X-ray diffraction instruments requiring rotations about two axes. Thus, this X-ray diffraction instrument has the advantage of simple structure, high diffraction intensity and short total measurement time.

JP-A 2005-351780 discloses an X-ray diffraction instrument including a two-dimensional X-ray detector that provides transmission diffraction measurement. This X-ray diffraction instrument includes: a specimen table for horizontally holding a specimen; an X-ray emitter for irradiating the specimen with an X-ray beam; an arm for actuating the X-ray emitter in such a way that the incident angle of the emitted X-ray beam relative to the specimen is set at a desired angle from 0° to 90°; and a partially-open cylinder made of a storage (photostimulable) phosphor that surrounds the specimen table for detecting the X-ray beams diffracted by the specimen. The phosphor cylinder is placed in such a manner that its axis is perpendicular to the emitted X-ray beam. The phosphor detector portion of the cylinder barrel extends circumferentially from 180° to 360° as measured from the horizontal (parallel to the table surface) on the side of the X-ray emitter, and more preferably from 100° to 360°, and the other portion of the cylinder barrel is open. The JP-A 2005-351780 X-ray diffraction instrument provides transmission diffraction measurement as well as reflection diffraction measurement.

However, the X-ray diffraction instruments of JP-A 2000-146871 and JP-A 2005-351780 require an actuator for adjusting the position and/or orientation of the specimen and/or the X-ray emitter, and thus have disadvantages of complicated structure and large size. In addition, the two-dimensional X-ray detectors used in the above disclosures are cylindrical in form, and surround a specimen for detecting the X-ray beams diffracted by the specimen. Therefore, there is some limitation on the size and shape of specimens measurable by these X-ray diffraction instruments. In general, specimens measurable by conventional X-ray diffraction instruments are limited to relatively small objects (such as laboratory samples).

Recently, there has been an increasing demand for on-site non-destructive inspection of the conditions (such as material abnormality and deterioration) of structural components of large apparatuses used in various plants. As described, most conventional X-ray diffraction instruments are large in size, and there is some limitation on the size and shape of specimens. Thus, conventional X-ray instruments are very difficult to use as a tool for inspecting structural components of large apparatuses both non-destructively and on-site.

### SUMMARY OF THE INVENTION

In view of the foregoing, it is an objective of the present invention to overcome the above-described problems and provide an X-ray diffraction instrument which does not require any actuator for adjusting a position and/or an orientation of a measurement object and/or an X-ray emitter used in the instrument and that has no particular limitation on a size and a shape of the object measurable by the invented X-ray diffraction instrument.

According to one aspect of the present invention, there is provided an X-ray diffraction instrument including:

a two-dimensional plate-like X-ray detector;

an X-ray emitter integrated with the X-ray detector in such a manner that the X-ray emitter penetrates the plate of the X-ray detector; and

a cylinder-like shield for defining an orientation of the X-ray emitter and preventing X-ray leakage, the X-ray detector being attached to an end of the cylinder-like shield in such a manner that a perimeter of the end of the shield abuts a perimeter of the plate of the X-ray detector.

As used herein and in the appended claims, the term “cylinder” or “cylindrical” does not only refer to a cylinder having a circular cross section, but also to a cylinder having any other cross section (such as tetragonal and polygonal) depending on a perimeter shape of a plate of an X-ray detector used.

In the above aspect of the present invention, the following modifications and changes can be made.

i) The cylinder-like shield is detachable and easily exchangeable for another cylinder-like shield.

ii) The X-ray detector is an imaging plate including a photostimulable phosphor layer.

iii) The cylinder-like shield blocks visible light.

iv) The imaging plate is contained in a cartridge that transmits X-ray but blocks visible light.

v) The imaging plate is detachable and easily exchangeable for another imaging plate.

vi) The X-ray detector is a position sensitive proportional counter.

vii) The X-ray emitter is equipped with a sighting device.

### Advantages of the Invention

According to the present invention, it is possible to provide an X-ray diffraction instrument which does not require any actuator for adjusting the position and/or orientation of a measurement object and/or the X-ray emitter used in the instrument and that has no particular limitation on the size and shape of objects measurable by the invented X-ray diffraction instrument. The invented X-ray diffraction instrument is small compared to conventional ones, and can be used for measurement of stationary immovable objects (e.g., on-site inspection of structural components of large apparatuses).

### BRIEF DESCRIPTION OF THE DRAWINGS

FIG. 1 is a schematic illustration showing a perspective view of an embodiment of an X-ray diffraction instrument according to the present invention.

FIG. 2 is a schematic illustration showing perspective views of cylinder-like shields having different tilt angles β.

FIG. 3 is a schematic illustration showing a perspective view of another embodiment of an X-ray diffraction instrument according to the present invention.

FIG. 4 is a schematic illustration showing a perspective view of an imaging plate as an example of a two-dimensional X-ray detector used in the invented X-ray diffraction instrument.

FIG. 5 is a schematic illustration showing a perspective view of still another embodiment of an X-ray diffraction instrument according to the present invention.

FIG. 6 is a schematic illustration showing a perspective view of an example of an X-ray diffraction instrument according to the present invention.

FIG. 7 shows an example of the image of an X-ray diffraction pattern.

### DETAILED DESCRIPTION OF THE PREFERRED EMBODIMENTS

Preferred embodiments of the present invention will be described below with reference to the accompanying drawings. In the drawings, like parts are designated by like reference numerals without repeating the description thereof. The invention is not limited to the specific embodiments described below, but various combinations and modifications are possible without departing from the spirit and scope of the invention.

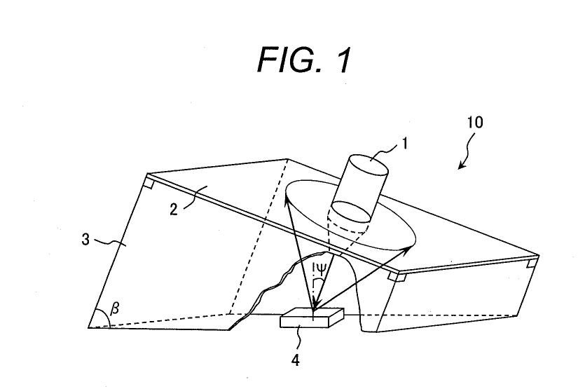

FIG. 1 is a schematic illustration showing a perspective view of an embodiment of an X-ray diffraction instrument according to the present invention. As illustrated in FIG. 1, an X-ray diffraction instrument 10 of the invention includes: a two-dimensional plate-like X-ray detector 2; an X-ray emitter 1 (such as an X-ray tube) integrated with the X-ray detector 2 in such a manner as to penetrate the X-ray detector 2; and a cylinder-like shield 3. The X-ray detector 2 is attached to an open end of the cylinder-like (tube) shield 3 in such a manner that a perimeter of the open end of the cylinder-like shield 3 abuts a perimeter of the plate of the X-ray detector 2. The cylinder-like shield 3 defines an orientation of the X-ray emitter 1 and prevents X-ray leakage between the inside of the cylinder-like shield 3 and the outside environment.

An X-ray beam emitted from the X-ray emitter 1 is incident on and diffracted by a measurement object 4, and then the diffracted X-ray beams are incident on and detected by the X-ray detector 2 where the diffraction pattern of the measurement object 4 is recorded. Here, the X-ray beams (the emitted X-ray beam and the diffracted X-ray beams) are surrounded and blocked by the cylinder-like shield 3. Thus, the above diffraction measurement can be carried out safely without any X-ray leakage. Preferably, the X-ray emitter 1 is equipped with an unshown sighting device (such as a laser pointer) for visibly showing a point on the measurement object 4 to be irradiated with the emitted X-ray beam. By using this sighting device, the X-ray diffraction instrument 10 can be easily positioned in such a manner that the X-ray emitter 1 emits an X-ray beam onto an exactly desired target area on the measurement object 4.

The X-ray emitter 1 is integrally and immovably fixed to the X-ray detector 2. The angle between the emitting axis of the X-ray emitter 1 and the plane of the X-ray detector 2 may be freely chosen depending on a surface contour of the measurement object 4, a type of X-ray diffraction analysis or other factors. However, the angle is preferably 90° because of the effective use of the X-ray receiving surface of the X-ray detector 2 and the analytical ease of the resulting diffraction pattern.

Also, a position of the X-ray emitter 1 in the plane of the X-ray detector 2 is not particularly limited, but may be freely chosen depending on a type of X-ray diffraction analysis. For example, when the entire circumferences of a relatively small number of Debye rings needs to be recorded, the X-ray emitter 1 is preferably located near the center of the plane of the X-ray detector 2. When the partial circumferences of relatively many Debye rings needs to be recorded, the X-ray emitter 1 is preferably located near a side edge of the plane of the X-ray detector 2.

The cylinder-like (tube) shield 3 defines an orientation of the X-ray emitter 1 as well as providing X-ray blocking. When the X-ray emitter 1 is perpendicularly fixed to the X-ray detector 2, the incident angle of the emitted X-ray beam (relative to the normal to the surface of the measurement object 4) and the tilt angle β of the cylinder-like shield 3 (relative to the surface of the measurement object 4) satisfy “Ψ=90°−β” (see FIG. 1). Thus, the incident angle Ψ can be changed by using a cylinder-like shield 3 having a different tilt angle β. In order to readily change the incident angle Ψ by exchange of the cylinder-like shield 3, the X-ray detector 2 is preferably detachably attached to the cylinder-like shield 3 when the X-ray emitter 1 is immovably fixed to the X-ray detector 2.

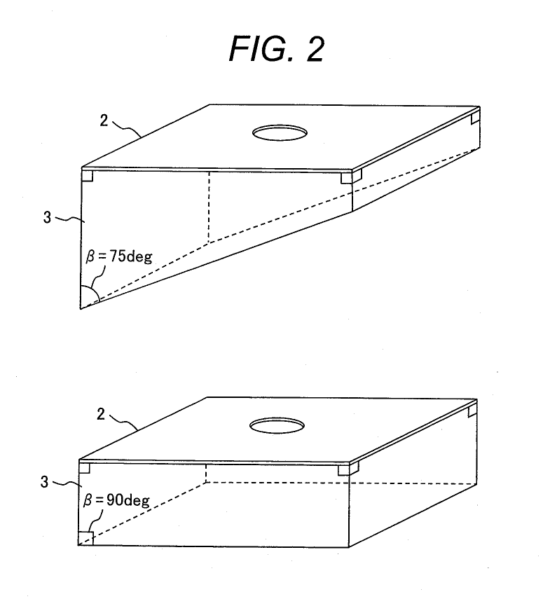

FIG. 2 is a schematic illustration showing perspective views of cylinder-like shields having different tilt angles β. As illustrated in FIG. 2, the incident angle Ψ can be set at 25° and 0° by using cylinder-like shields 3 having tilt angles β of 75° and 90°, respectively.

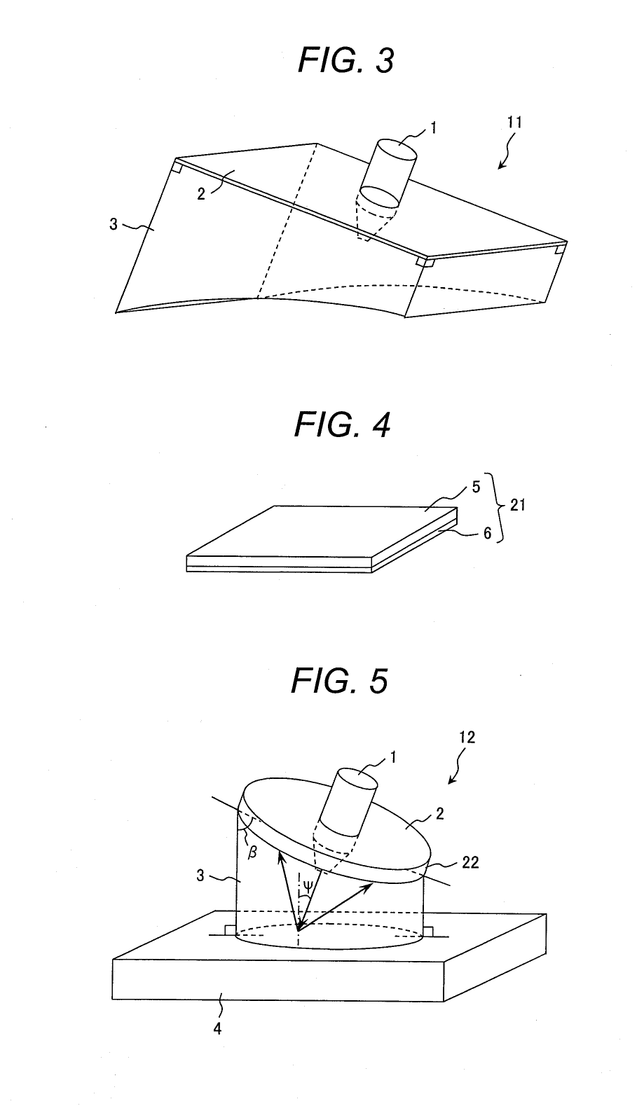

FIG. 3 is a schematic illustration showing a perspective view of another embodiment of an X-ray diffraction instrument according to the present invention. In the X-ray diffraction instrument 11 illustrated in FIG. 3, the lower end of the cylinder-like shield 3 (on the side of an unshown underlying measurement object) is shaped so as to conform to a surface contour of the underlying measurement object. By this configuration, X-ray diffraction measurement can be performed also for objects having a curved surface (such as large diameter pipes) for which X-ray diffraction measurement has previously been difficult. The cylinder-like shield 3 is preferably made of a plastic material because of the good formability and the light weight.

FIG. 4 is a schematic illustration showing a perspective view of an imaging plate as an example of a two-dimensional X-ray detector used in the invented X-ray diffraction instrument. As illustrated in FIG. 4, the imaging plate 21 includes; a support plate 5 made of a plastic or the like; and an X-ray receiving layer 6 made of a photostimulable phosphor (BaFX:Eu²⁺, X=Br, I) formed on the support plate 5. The imaging plate 21 is illustrated as being rectangular in FIG. 4, but any other shape is also possible.

The BaFX:Eu²⁺ (X=Br, I) photostimulable phosphor has a wide dynamic range and high sensitivity to a wide variety of ionizing radiations. It also has a high spatial resolution. In addition, it can be formed into large shapes, thus enabling large area two-dimensional X-ray detection. When the BaFX:Eu²⁺ (X=Br, I) photostimulable phosphor is irradiated with an ionizing radiation beam, electron-hole pairs are generated in the phosphor crystal and the electrons generated are trapped to form metastable color centers. The amount of the trapped electrons is proportional to the irradiation amount.

When the photostimulable phosphor having the color centers formed therein is irradiated with an excitation light (such as He—Ne laser), the radiation energy stored in the phosphor is released by photostimulated luminescence. This mechanism is utilized in the imaging plate 21 as follows: After the imaging plate 21 is irradiated with an X-ray diffraction pattern and color centers are formed, the phosphor on the imaging plate 21 is photostimulated by scanning a laser beam two-dimensionally across the surface of the imaging plate 21. Then, the resulting photostimulated luminescence signals are sequentially detected with a photomultiplier tube (PMT) or the like and recorded as a time series signal. In this manner, the intensity distribution of the X-ray diffraction pattern recorded can be read out.

Color centers formed in photostimulable phosphors can be removed by exposure to visible light. Therefore, the imaging plate 2 using a photostimulable phosphor can be repeatedly used. In other words, in order to prevent destruction of an X-ray diffraction pattern stored on the imaging plate 2, the imaging plate 2 is preferably prevented from exposure to visible light during the X-ray diffraction measurement. For example, the cylinder-like shield 3 preferably shields the imaging plate 21 from both X-ray and visible light. Alternatively, the imaging plate 21 may be contained in a cartridge that transmits X-ray but blocks visible light. In this case, the cylinder-like shield 3 does not necessarily block visible light. Preferably, the imaging plate 21 is detachable and easily exchangeable in view of the operability and usability of the X-ray diffraction instrument 10.

FIG. 5 is a schematic illustration showing a perspective view of still another embodiment of an X-ray diffraction instrument according to the present invention. As illustrated in FIG. 5, the X-ray diffraction instrument 12 of this embodiment employs a two-dimensional position sensitive proportional counter 22 as the plate-like X-ray detector 2. The use of the position-sensitive proportional counter 22 enables simultaneous measurement and recording (imaging) of an X-ray diffraction pattern. FIG. 5 illustrates an exemplary configuration in which the integral assembly of the counter 22 and the X-ray emitter 1 is attached obliquely (90°−β) to the upper end of the cylinder-like shield 3 (on the side of the counter 22) so that the emitted X-ray beam impinges on the surface of the measurement object 4 at an incident angle Ψ.

As has been described, in the invented X-ray diffraction instrument, a two-dimensional plate-like X-ray detector and an X-ray emitter are integrally fixed to each other, which are together attached to a cylinder-like shield. The cylinder-like shield works to define an orientation of the X-ray emitter. Thus, the invented X-ray diffraction instrument does not require any actuator for adjusting the orientation of the X-ray emitter, and thus can be made smaller and lighter than conventional X-ray diffraction instruments.

As mentioned above, the cylinder-like shield works both to protect X-ray and to define the orientation of the X-ray emitter (see FIG. 2). It also works to adjust the invented X-ray diffraction instrument to a shape and a size of a measurement object (see FIG. 4). Thus, there is no particular limitation on the shape and size of objects measurable by the invented X-ray diffraction instrument. Thus, the invented X-ray diffraction instrument can be particularly advantageously used to measure X-ray diffraction patterns of large and/or immovable objects.

The above described imaging plate and position-sensitive proportional counter used as the two-dimensional X-ray detector 2 can both achieve the above-described advantages of the invention. Imaging plates have the advantages of simple structure and low cost. In addition, they can be easily formed to a desire shape and size so as to be suited to an object to be measured. On the other hand, two-dimensional position sensitive proportional counters have disadvantages of a complicated structure and high cost compared to imaging plates, but have advantages of being able to simultaneously provide both a high precision X-ray diffraction measurement and the recording (imaging) of the measurement result. The choice between these two types is made depending on the application.

### EXAMPLES

The present invention will be described more specifically below by way of an example. However, the invention is not limited to the specific example below.

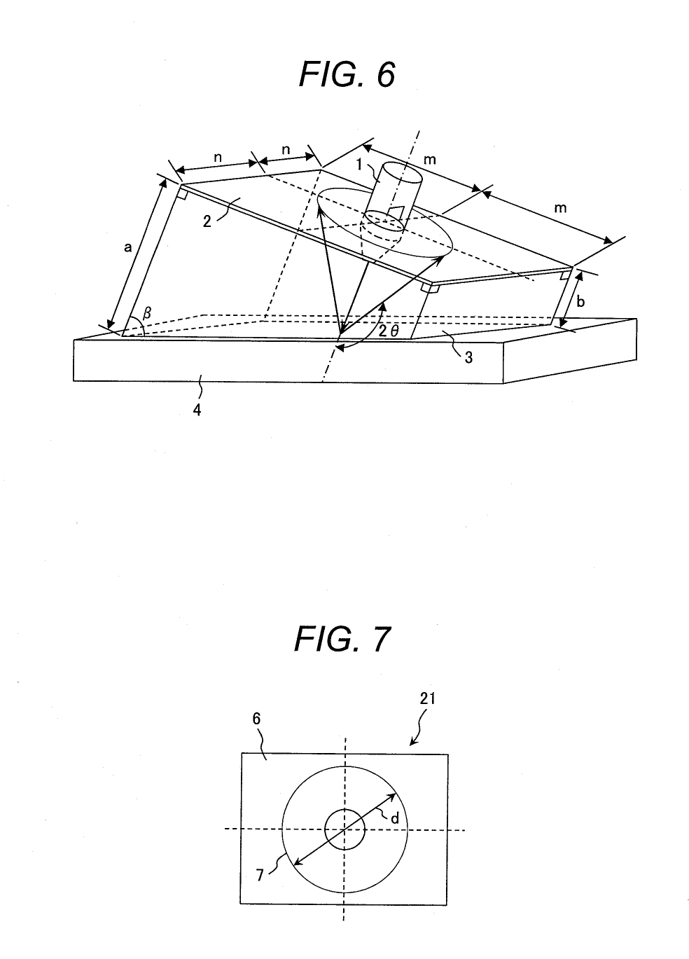

FIG. 6 is a schematic illustration showing a perspective view of an example of an X-ray diffraction instrument according to the present invention, where a=40 mm, b=16 mm, m=25 mm, n=18 mm, and β=75°. As illustrated in FIG. 6, an X-ray emitter 1 was integrally secured to a two-dimensional X-ray detector 2 in such a manner as to perpendicularly penetrate through a central portion of the X-ray detector 2. The integral assembly of the X-ray emitter 1 and the X-ray detector 2 was attached to an end of a cylinder-like shield 3 in such a manner that a perimeter of the end of the cylinder-like shield 3 abuts a perimeter of the X-ray detector 2.

An imaging plate was used as the two-dimensional X-ray detector 2 and an Mn (manganese) target X-ray tube was used as the X-ray emitter 1. A measurement object 4 (2000 mm×1000 mm×300 mm) was irradiated with an Mn—Kα line (wavelength: 2.10314×10⁻¹⁰ m), and the resulting X-ray diffraction pattern was detected and recorded as image data. FIG. 7 shows an example of the image of an X-ray diffraction pattern. As shown in FIG. 7, an X-ray diffraction pattern (Debye ring) 7 with a diameter d was captured on a receiving surface 6 of the imaging plate 21. A piece of information on the crystallographic structure of the measurement object 4 can be obtained from the diffraction angle 2θ and wavelength of the incident X-ray beam. Here, the diffraction angle 2θ is given by “arctan{d/(a+b)}” where “(a+b)/2” is a distance between the center of the Debye ring 7 and the X-ray beam incident point on the measurement object 4, and “d” is the diameter of the Debye ring 7.

Although the present invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An X-ray diffraction instrument comprising:
a two-dimensional plate-like X-ray detector;
an X-ray emitter integrated with the X-ray detector in such a manner that the X-ray emitter penetrates the plate of the X-ray detector; and
a cylinder-like shield for defining an orientation of the X-ray emitter and preventing X-ray leakage, the X-ray detector being attached to an end of the cylinder-like shield in such a manner that a perimeter of the end of the shield abuts a perimeter of the plate of the X-ray detector.

2. The X-ray diffraction instrument according to claim 1, wherein the cylinder-like shield is detachable and easily exchangeable for another cylinder-like shield.

3. The X-ray diffraction instrument according to claim 1, wherein the X-ray detector is an imaging plate including a photostimulable phosphor layer.

4. The X-ray diffraction instrument according to claim 3, wherein the cylinder-like shield blocks visible light.

5. The X-ray diffraction instrument according to claim 3, wherein the imaging plate is contained in a cartridge that transmits X-ray but blocks visible light.

6. The X-ray diffraction instrument according to any one of claim 3, wherein the imaging plate is detachable and easily exchangeable for another imaging plate.

7. The X-ray diffraction instrument according to claim 1, wherein the X-ray detector is a position sensitive proportional counter.

8. The X-ray diffraction instrument according to claim 5, wherein the X-ray emitter is equipped with a sighting device.

9. The X-ray diffraction instrument according to claim 7, wherein the X-ray emitter is equipped with a sighting device.
